(19) United States
(12) Patent Application Publication
(10) Pub. No.: US 2025/0099918 A1
(43) Pub. Date: Mar. 27, 2025

(54) COATED POROUS FILTER MEMBRANES AND RELATED METHODS

(71) Applicant: ENTEGRIS, INC., Billerica, MA (US)

(72) Inventors: Alketa Gjoka, Medford, MA (US); Jad Ali Jaber, Westford, MA (US); Clifton G. Ngan, Chelmsford, MA (US); James Hamzik, North Billerica, MA (US); David Crespo, Methuen, MA (US); Saksatha Ly, Lexington, MA (US); Christopher W. Webb, Littleton, MA (US); Jikku Thomas, Woburn, MA (US); Satoshi Kamimoto, Yokohama-shi (JP); Gaurav M. Batra, Cambridge, MA (US); Siddarth Sampath, Tyngsboro, MA (US)

(21) Appl. No.: 18/891,895

(22) Filed: Sep. 20, 2024

Related U.S. Application Data
(60) Provisional application No. 63/539,998, filed on Sep. 22, 2023.

(51) Int. Cl. B01D 69/02; B01D 69/10; B01D 71/40; B01D 71/56; C02F 1/44; C02F 101/20

(52) U.S. Cl. CPC B01D 69/02; B01D 69/107; B01D 71/401; B01D 71/56; C02F 1/44; B01D 2325/14; B01D 2325/16; C02F 2101/203

(57) ABSTRACT

Described are coated porous polymeric filter membranes that include a filter membrane substrate and an ionic polymer coating applied to the surface of the substrate; methods of making the coated porous polymeric filter membranes and filters that include such a coated membrane; and method of using the coated membranes to remove metal ions from purified water.

### CROSS-REFERENCE TO RELATED APPLICATIONS

The present application claims priority to and benefit of U.S. Provisional Patent Application No. 63/539,998, filed Sep. 22, 2023, the entirety of which is incorporated herein by reference.

### FIELD OF THE INVENTION

The present disclosure relates to coated porous polymeric filter membranes that include a filter membrane substrate and an ionic polymer coating applied to the surface of the substrate; to methods of making the coated porous polymeric filter membranes and filters that include such a coated membrane; and to method of using the coated membranes to remove metal ions from purified water.

### BACKGROUND

Porous polymeric filter membranes are used in industry to remove metal ions from purified water. In specific applications, these membranes are used to remove metal ions from highly purified water for use in semiconductor and microelectronic device manufacturing.

Generally, polymeric filter membranes can remove unwanted impurities from a liquid by different mechanisms, such as by size exclusion (sometimes referred to as a “sieving” mechanism) or by chemical or electrostatic attraction between the membrane and the impurity (sometimes referred to as a “non-sieving” mechanism). According to non-sieving filtration mechanisms, chemical features of a filter membrane surface such as a chemical charge may produce a chemical or electrostatic attraction between the membrane and a charged impurity that is dissolved in a fluid that passes over the membrane surface, trapping the dissolved impurity such as by an ionic, coordinative, chelation, or hydrogen-bonding interaction.

The removal of ionic materials such as dissolved metal ions from a liquid solution, e.g., purified water, is a very important process used in the semiconductor and microelectronics manufacturing industry. Ionic contaminants such as dissolved metals present in a liquid, in even minutely small concentrations (e.g., in a part-per-million or a part-per-billion range), can adversely affect the quality and performance of microelectronic devices by producing defects, impeding proper functioning of the device, and generally reducing process yields. With purified water being commonly used to perform multiple different process steps used in microelectronic and semiconductor device manufacturing, it is particularly desirable to remove dissolved metal ions from already highly purified water used in those processes.

Commercially useful membranes are designed to achieve a useful combination of filtering performance properties that include filtration efficacy (e.g., measured as a percentage of impurities that are removed from a fluid, or “retention”) and flow rate of a fluid through the filter membrane. Desired filter membranes can exhibit a combination of high filtering performance (high retention of impurities) with a high rate of flow of fluid through the membrane. But these properties are often available in a balanced relationship, for example increasing filtration efficacy or “retention” can result in a reduced rate of flow through the filter membrane.

Among commercial filter products that are used for removing metal ions from purified water, there is ongoing need to improve membrane performance in terms of removal efficiency of metal ions (particularly with heavy metal ions such as vanadium, molybdenum, tin, tantalum, and tungsten, most particularly molybdenum and tungsten ions) while still allowing a relatively high rate of flow of the purified water through a filtering membrane.

Efforts to improve filtering performance (removal efficiency) have included applying chemical coatings to polymeric filter membranes. Past attempts to use chemical coatings to improve the performance of filter membranes have produced mixed performance results. For example, a coating may potentially improve removal efficiency, but with the unwanted effect of reducing a flow rate of fluid through the coated filter membrane due to the added physical presence of the coating at the filter membrane surface.

### SUMMARY

Accordingly, there remains an ongoing need for filter membranes that are useful to remove metal ions from purified water, particularly for filter membranes that are effective to remove a high percent of metal ions from a flow of water, while also being capable of doing so with a high rate of flow of the water through the filter membrane.

The present disclosure relates to coated porous membranes that include a porous polymeric membrane substrate (e.g., “membrane substrate,” “substrate,” or the like) and an ionic polymer coating applied to the surface of the substrate. The present disclosure also relates to methods of preparing the described coated porous membranes, methods of using the described coated porous membranes to remove metal ions from water, and filter products that contain the coated membrane.

Normally when a polymer coating is applied to a porous membrane, the physical presence of the coating on the membrane has the undesired effect of reducing a flow rate. Flow rate may be measured as a flow rate (volume per time) or may be measured as “flow time,” which is an inverse of flow rate (a reduced flow rate results in an increased flow time). Methods of the present disclosure allow a polymer coating to be applied to a substrate surface in a manner that achieves a reduced negative impact on flow rate and flow time of liquid through the membrane substrate, i.e., a reduced “flow penalty” caused by the presence of the polymer coating.

According to example methods, a monomer solution that contains reactive monomers in a solvent is applied to a surface of a porous polymeric membrane substrate. The monomer solution is dried to remove solvent from the monomer solution. The dried monomer coating is then re-wet using a wetting solvent. The re-wetted monomer is then reacted to form a polymer coating at the substrate surface. The polymer coating can be further processed such as to remove the wetting solvent from the polymer coating, followed by drying.

Coated membranes as described can exhibit useful or improved filtering performance properties such as a combination of good removal efficiency (particularly of heavy metal ions) and a high flow rate of water (measured as deionized water “flowtime”) that can pass through a coated membrane during a filtration step.

In one aspect, the invention relates to a coated porous polymeric membrane that is capable of removing metal ions from purified water. The coated porous membrane comprises a porous polymeric membrane substrate and an ionic polymer coating at a surface of the porous polymeric membrane substrate. The porous polymeric membrane substrate exhibits a substrate flow time measured as deionized water flow time, and a bubble point in a range from 2 to 200 pounds per square inch measured using ethoxy-nonafluorobutane. The coated porous polymeric membrane exhibits a coated membrane flow time measured as deionized water flow time. For a porous polymeric membrane substrate having a bubble point below 80 pounds per square inch, the coated membrane flow time is not more than 30 percent greater than the membrane substrate flow time. For a porous polymeric membrane substrate having a bubble point between 80 and 140 pounds per square inch, the coated membrane flow time is not more than 40 percent greater than the membrane substrate flow time. For a porous polymeric membrane substrate having a bubble point above 140 pounds per square inch, the coated membrane flow time is not more than 50 percent greater than the membrane substrate flow time. The ionic polymer coating comprises monomeric units derived from ionic monomer and crosslinker monomer.

In another aspect, the invention relates to a method of preparing a coated porous polymeric membrane capable of removing metal ions from purified water, comprising a porous polymeric membrane substrate and an ionic polymer coating at a surface of the membrane substrate. The method includes: to a surface of a porous polymeric membrane substrate, applying monomer solution comprising ionic monomer, crosslinker monomer, solvent, and optional initiator; drying the monomer solution on the surface to remove solvent from the monomer solution and form dried monomer coating at the surface; wetting the dried monomer coating with wetting solvent to form re-wetted monomer coating at the surface; reacting monomer of the re-wetted monomer to form ionic polymer coating at the surface.

### BRIEF DESCRIPTION OF THE DRAWING

Drawings are presented herein for illustration purposes, not for limitation. The foregoing and other objects, aspects, features, and advantages of the disclosure will become more apparent and may be better understood by referring to the following description taken in conjunction with the accompanying drawings, in which:

FIG. 1 schematically shows a series of steps useful for preparing a coated membrane, according to illustrative embodiments of the present disclosure

FIG. 2 shows an example filter product as described, according to illustrative embodiments of the present disclosure;

FIGS. 3 through 11 show data relating to coated membranes as described, according to illustrative embodiments of the present disclosure;

FIG. 12 presents a calibration curve showing the absorbance of four methylene blue dye solutions with known concentrations which may be useful in characterizing disclosed embodiments, according to illustrative embodiments of the present disclosure;

FIG. 13 presents a calibration curve showing the absorbance of four Ponceau S dye solutions with known concentrations which may be useful in characterizing disclosed embodiments, according to illustrative embodiments of the present disclosure; and

FIG. 14 presents a plot of surface tension in dynes/cm of aqueous solutions of MeOH, according to illustrative embodiments of the present disclosure.

### DETAILED DESCRIPTION

It is contemplated that systems, devices, methods, and processes of the disclosure encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems according to certain embodiments of the present disclosure that consist essentially of, or consist of, the recited components, and that there are processes and methods according to certain embodiments of the present disclosure that consist essentially of, or consist of, the recited processing steps.

It should be understood that the order of steps or order for performing certain action is immaterial so long as operability is not lost. Moreover, two or more steps or actions may be conducted simultaneously. As is understood by those skilled in the art, the terms “over”, “under”, “above”, “below”, “beneath”, and “on” are relative terms and can be interchanged in reference to different orientations of the layers, elements, and substrates included in the present disclosure. For example, a first layer on a second layer, in some embodiments means a first layer directly on and in contact with a second layer. In other embodiments, a first layer on a second layer can include another layer there between.

Headers are provided for the convenience of the reader and are not intended to be limiting with respect to the claimed subject matter.

The present disclosure relates to coated porous polymeric membranes (e.g., “coated porous membranes,” “coated membranes,” or sometimes simply “membranes”) that are useful for removing metal ions from purified water such as deionized water (e.g., DIW) or ultrapure water (UPW). The coated porous polymeric membranes include a porous polymeric membrane substrate (e.g., “membrane substrate,” “substrate,” or the like) and an ionic polymer coating applied to the surface of the substrate. The present disclosure also relates to methods of preparing the coated porous membranes, methods of using the coated porous membranes to remove metal ions from water, and filter products that contain the coated porous membranes.

### Coated Porous Membranes

A coated porous membrane can be prepared by steps that produce a coated membrane that exhibits the useful combination of filter performance properties that include high flow and high filtering retention. By example methods, a liquid coating composition (e.g., “monomer solution”) is applied to a surface of a porous polymeric membrane substrate. The monomer solution contains ionic monomer, crosslinking monomer, solvent, and optional initiator. Generally, the monomer solution is applied to the substrate surface and is subsequently dried by removing the solvent from the monomer solution to form a dried monomer coating at the substrate surface. The dried monomer coating is then re-wetted using a wetting solvent to form a re-wetted monomer coating at the surface. The monomers contained in the re-wetted monomer coating are then reacted (“polymerized”) to form an ionic polymer coating at the surface. The ionic polymer coating can be further processed, for example to remove the wetting solvent from the ionic polymer coating.

Compared to other polymer coatings that are applied to porous membrane surfaces by different methods, polymer coatings that are applied to a porous membrane surface by a presently described method can be specifically and advantageously capable of forming the coating in a manner that provides a coated membrane that has a desirable combination of removal efficiency of metal ions from purified water, with relatively high flow rate of purified water through the filter. Generally, by any method of applying a polymer coating to a porous membrane substrate, the physical presence of the coating on the substrate surface can have the undesired effect of reducing a flow rate (e.g., as measured by deionized water “flow time”) of liquid through the substrate, a “flow penalty.” Compared to other methods of applying coatings to porous membranes, coating steps and techniques as described allow a polymer coating to be applied to a substrate surface in a manner that achieves a reduced negative impact or “flow penalty” on flow rate of liquid through the membrane substrate.

Generally, the presence of a coating on a substrate surface negatively affects a flow rate of fluid through the coated membrane (sometimes referred to as a “coated membrane flow rate”). For example, the coated membrane flow rate will be reduced compared to the flow rate of fluid through the un-coated membrane substrate (sometimes referred to as the “substrate flow rate”). According to methods and membranes as described, coated membranes of the present disclosure advantageously exhibit a lower reduction in flow rate (e.g., a reduced increase in flow time) through the membrane substrate due to the presence of the applied coating, e.g., compared to a reduction in flow rate (or an increase in flow time) that is caused by polymer coatings applied by other coating methods.

The reduced negative impact on flow caused by the presence of the polymer coating can be achieved by using certain steps to apply the coating, including steps of drying and re-wetting the monomer solution before causing the reactive monomers of the monomer solution to react and polymerize to form the ionic polymer coating. After the monomer solution is applied to the substrate surface, the monomer solution is dried to form a dried monomer coating at the surface of the membrane. The dried monomer coating is then wetted (re-wetted) with wetting solvent to form a re-wetted monomer coating that remains substantially at the substrate surface, i.e., applying the wetting solvent to the dried monomer coating does not cause a substantial amount of the dried monomer coating to be removed from the membrane surface. The monomer of the re-wetted monomer coating is then reacted by a polymerization reaction to form an ionic polymer coating at the surface. The ionic polymer coating that is formed in this manner has a lower reduction in flow rate (lower increase in flow time) compared to a polymer coating that is applied without drying and re-wetting the monomer after applying the monomer solution and before reacting the reactive monomers to form the polymer coating.

A reduction in flow rate of purified water through the membrane substrate that is caused by the presence of the ionic polymer coating at the substrate surface can be measured by a comparison of the flow rate of the coated membrane (the coated membrane flow rate) to the flow rate of the membrane substrate before the ionic polymer coating is applied. A flow rate can be measured as a volume of fluid that flows through an area of filter at defined pressure per time (volume/(time*area*pressure); membrane flow rate can have dimensions of mL/(min cm² bar) or LMH/bar.

Alternately, a reduction in flow rate of fluid through a coated substrate can be measured by a comparison of the flow time of the coated membrane (the “coated membrane flow time”) to the flow time of the membrane substrate before the ionic polymer coating is applied (“substrate flow time”). A “flow time” (time/pressure/volume of fluid) measurement is an inverse of the flow rate.

Examples of useful methods are capable of producing a coated membrane that exhibits a coated membrane flow rate that is at least 20, 30, 40, 50, or 60 percent of the substrate flow rate. In terms of flow time, useful methods can produce a coated membrane that exhibits a coated membrane flow time that is increased by not more than 20, 30, 40, or 50 percent compared to the flow time of the un-coated substrate (substrate flow time).

The reduction in flow rate or the increase in flow time, i.e., a “flow penalty” that is caused by the presence of the coating added to the membrane substrate is reduced by use of a method as described, compared to other methods of applying the coating, but can vary based on features of the membrane substrate, particularly pore size or bubble point of the membrane substrate. A membrane substrate that has a relatively larger pore size (lower bubble point) may generally be affected with a relatively lower flow penalty (reduced flow rate, increased flow time), while a membrane substrate that has a relatively smaller pore size (higher bubble point) will be affected with a relatively higher flow penalty; a flow time increase will be relatively higher for a membrane having a higher bubble point (smaller pores) and will be relatively lower for a membrane having a lower bubble point (larger pores).

In example membranes, a membrane substrate having a bubble point below 80 pounds per square inch can be coated to produce a coated membrane having a coated membrane flow time that is increased by not more than 30 percent relative to the membrane substrate flow time; a membrane substrate having a bubble point between 80 and 140 pounds per square inch can be coated to produce a coated membrane having a coated membrane flow time that is increased by not more than 40 percent relative to membrane substrate flow time, and a membrane substrate having a bubble point above 140 pounds per square inch can be coated to produce a coated membrane having a coated membrane flow time that is increased by not more than 50 percent relative to a membrane substrate flow time.

Furthermore, example coated membranes as described can be useful to remove metal ions from a flow of purified water. The water initially has a very high level of purity and may be of a type used for manufacturing semiconductor and microelectronic devices, including purified water of a type referred to as “ultrapure water” (also known at Type I water). The purified water initially may contain impurities in the form of metal ions at a concentration that is less than 100 ppm, 1 ppm, 100 ppb, or 100 ppt, on an individual basis (per impurity) or as a total of all types of impurities.

A coated membrane as described can be useful to remove various metal ions from purified water, including Li, Be, Na, Mg, Al, K, Ca, Ti, V, Cr, Mn, Ni, Co, Cu, As, Mo, Sn, Ta, and W. Example coated membranes may be effective particularly to remove heavy metal cations from purified water, including, V, Mo, Sn, Ta, and W.

A coated membrane as described can be effective to remove metal ion impurities from purified water. A level of effectiveness of a coated membrane in terms of an ability to remove metal ions from a flow of purified water can be defined by “retention.” Retention generally refers to a measure of the amount of an metal ion (actual or during a performance test) that is removed from a flow of purified water that contains the metal ion, relative to the total amount of the metal ions (individually or in total) that is initially present in the purified water before passing the water through the coated membrane. The “retention” value is a percentage, with a coated membrane that has a higher retention value (a higher percentage) being relatively more effective in removing metal ions from the purified water, and a coated membrane having a lower retention value (a lower percentage) being relatively less effective in removing metal ions from the purified water.

Example coated membranes as described may be useful to remove at least 40 percent of one or more of the following metal ions: vanadium, molybdenum, tin, tantalum, and tungsten, from purified water. These or other example coated membranes may also be useful to remove at least 60 percent of one or more of the following metal ions: molybdenum, tin, tantalum, and tungsten, from purified water.

### Monomer Solutions

Disclosed monomer solutions contain reactive monomers that include a reactive ionic monomer (“ionic monomer”) in combination with at least one additional reactive monomer (“crosslinker”). Ionic monomers and crosslinkers are capable of reacting together to form an ionic polymer that includes a polymeric backbone derived from the reactive monomers. Ionic polymers contains ionic groups along the length of the polymer. When present at a substrate surface, the ionic polymer is referred to as an “ionic polymer coating.”

Monomer solutions also contain solvent of a suitable type and in an amount sufficient to carry the reactive monomers during a coating step that applies the reactive monomers to surfaces of the membrane substrate, including interior surfaces of porous membrane substrates. Monomer solutions may also contain an initiator (e.g., a “radical initiator”) that is capable of initiating a chemical reaction between the reactive monomers to produce the ionic polymers.

Reactive monomers include individual monomeric compounds (typically single monomer compounds, but optionally oligomers, pre-polymers, etc.), that can be reacted, e.g., polymerized, to form ionic polymer that contains a polymer backbone derived from the monomers. As reacted constituents of the polymer, the monomers that are reacted to form the polymer backbone may be referred to as “monomeric units” of the polymer. The polymer backbone contains monomeric units that are derived from the ionic monomer, and those monomeric units will exhibit an ionic charge as part of the ionic polymer.

Disclosed ionic monomers can be any reactive monomer that exhibits an ionic charge as a monomer (e.g., a cationic monomer having a positive charge, an anionic monomer having a negative charge, or a zwitterionic monomer having both a positive and a negative charge), and that can be effectively reacted with reactive crosslinker monomer to form a ionic polymer that includes monomeric units derived from the ionic monomer and that exhibits an ionic charge as part of the polymer.

### Cationic Monomers

Cationic monomers that can be reacted to produce cationic polymer include one or a combination of cationic monomers having, as part of the same molecule: a cationic group, and one or more reactive (e.g., ethylenic unsaturated) groups. Example monomers include multiple, e.g., two, reactive groups that are ethylenically unsaturated, meaning groups that include a reactive carbon-carbon double bond. Example monomers may contain as a cationic group a cationically (+) charged nitrogen atom substituted by two reactive ethylenically unsaturated alkyl groups, and two saturated alkyl (e.g., methyl) groups.

Exemplary useful cationic monomers include: dimethyl aminoethyl methacrylate (DMAEMA); methacrylamido propyl trimethyl ammonium chloride (MAPTAC), acrylamido propyl trimethyl ammonium chloride (APTAC); diallyl dimethyl ammonium chloride (or “DADMAC”), 2-(dimethylamino)ethyl hydrochloride acrylate, [2-(acryloyloxy)ethyl]trimethylammonium chloride, 2-aminoethyl methacrylate hydrochloride, N-(3-aminopropyl) methacrylate hydrochloride, [3-(methacryloylamino)propyl]trimethylammonium chloride solution, [2-(methacryloyloxy)ethyl]trimethylammonium chloride, acrylamidopropyl trimethylammonium chloride, 2-aminoethyl methacrylamide hydrochloride, N-(2-aminoethyl) methacrylamide hydrochloride, N-(3-aminopropyl)-methacrylamide hydrochloride, diallyldimethylammonium chloride, allylamine hydrochloride, vinyl imidazolium hydrochloride, vinyl pyridinium hydrochloride, vinyl benzyl trimethyl ammonium chloride, and acrylamido propyl trimethylammonium chloride (APTAC), either individually or in combinations of two or more thereof. Monomers that can be positively charged in an organic solvent, either naturally or by treatment, can be polymerized and crosslinked with crosslinker monomer form a coating on the porous membrane that is also positively charged when in contact with an organic solvent.

### Anionic Monomers

Anionic monomers that can be reacted to produce anionic polymer include one or a combination of ionic monomers having, as part of the same molecule: an anionic and one or more reactive (e.g., ethylenic unsaturated) groups. Example monomers include multiple, e.g., two, reactive groups that are ethylenically unsaturated, meaning groups that include a reactive carbon-carbon double bond.

Specific examples of useful anionic monomers include: 2-ethylacrylic acid, acrylic acid, 2-carboxyethyl acrylate, 3-sulfopropyl acrylate potassium salt, 2-propyl acrylic acid, 2-(trifluoromethyl) acrylic acid, methacrylic acid, 2-methyl-2-propene-1-sulfonic acid sodium salt, mono-2-(methacryloyloxy)ethyl maleate, 3-sulfopropyl methacrylate potassium salt, 2-acrylamido-2-methyl-1-propanesulfonic acid, 3-methacrylamido phenyl boronic acid, vinyl sulfonic acid, and vinyl phosphonic acid, either individually or combinations of two or more thereof. Anionic monomers that are negatively charged in an organic solvent, either naturally or by treatment can be polymerized and crosslinked with a crosslinking monomer to form a coating on a porous membrane that is negatively charged in an organic solvent.

### Zwitterionic Monomers

Zwitterionic monomers that can be reacted to produce zwitterionic polymer include one or a combination of zwitterionic monomers having, as part of the same molecule: an anionic group, a cationic group, and one or more reactive (e.g., ethylenic unsaturated) groups. Example monomers include multiple, e.g., two, reactive groups that are ethylenically unsaturated, meaning groups that include a reactive carbon-carbon double bond.

Exemplary useful zwitterionic monomers include: [3-(Methacryloylamino) propyl]dimethyl (3-sulfopropyl) ammonium hydroxide; [2-(Methacryloyloxy)ethyl]dimethyl-(3-sulfopropyl) ammonium hydroxide; 2-(Methacryloyloxy)ethyl 2-(Trimethylammonio)ethyl Phosphate; 1-(3-Sulfopropyl)-2-vinylpyridinium hydroxide; and combinations.

### Crosslinker Monomers

The reactive monomers additionally include at least one multi-functional, uncharged reactive compound referred to as a “crosslinker” or “crosslinker monomer” that is capable of being reacted with the ionic monomer to form ionic polymer. The reacted crosslinker monomer becomes incorporated into the ionic polymer backbone as an uncharged monomeric unit of the polymer. The crosslinker monomer can be any reactive monomer that is un-charged, and that can be effectively reacted with ionic monomer to form ionic polymer that includes a backbone that includes un-charged monomeric units derived from the crosslinker monomer and ionically-charged monomeric units derived from the ionic monomer.

Example crosslinker monomers include one or a combination of un-charged monomers having one or more reactive (e.g., ethylenic unsaturated) groups available to react with reactive groups of the ionic monomer to form the ionic polymer. Specific examples include un-charged (non-ionic) compounds that have multiple (e.g., two) reactive groups that are ethylenically unsaturated, meaning groups that include a reactive carbon-carbon double bond. Examples may contain the unsaturated groups attached to an alkyl chain or attached to an alkyl chain that contains one or more heteroatoms (e.g., un-charged nitrogen atoms) within the alkyl chain. More specific examples include alkyl, amide, or di-amide compounds that include two or more reactive unsaturated groups such as ethylenic (vinyl), acrylate, (meth)acrylate, or acrylamide groups, including uncharged monomers that may be referred to as di-ethylenically-unsaturated monomers, and bis-acrylamide monomers (“di-acrylamide” monomers).

Exemplary useful crosslinker monomers include ethoxylated trimethylpropane triacrylate and N,N′-methylene bis acrylamide (MBAM).

### Solvents

Disclosed monomer solutions contain solvents of a suitable type and in an amount sufficient to carry the reactive monomers, in solution, as the monomer solution is applied to the substrate. Solvents may be of any useful type that will effectively carry the reactive monomers without negatively affecting (e.g., chemical degradation) the reactive monomers or the substrate. Examples include organic compounds that are known to be effective as solvents for carrying reactive monomers, e.g., alkyl compounds, alkanol compounds (e.g., methanol, isopropanol), and unsaturated compounds, any of which may also include a heteroatom.

### Initiators

Disclosed monomer solutions can optionally further include a radical initiator (“initiator”) that can facilitate crosslinking of reactive monomers when the monomers are exposed to electromagnetic radiation. Examples of suitable radical initiators include: dialkylperoxides, such as di-tertbutyl-peroxide and 2,5-dimethyl-2,5-di(tertbutylperoxy) hexane, dicumyl peroxide, ammonium persulfate, dibenzoyl peroxide, ditertbutyl perbenzoate, di-1,3-dimethyl-3-(tertbutylperoxy)butylcarbonate. To be present during a polymerization reaction, initiator may be either included in the monomer solution or may alternately be applied to the membrane substrate surface separately (e.g., before) the monomer solution is applied.

According to example monomer solutions, reactive monomers, solvent, and optional initiator can be present in amounts and relative amounts that are useful to form an ionic polymer coating as described.

The amount of ionic monomer in a monomer solution can be an amount that allows the monomer solution to be applied to a substrate surface as part of the monomer solution, then processed by steps as described herein to produce an ionic polymer coating at a membrane surface. Additionally, the amount can be effective to produce a coated membrane that exhibits membrane properties (e.g., porosity, bubble point, charge density) and filter performance properties (e.g., flow rate and retention) as described. Example monomer solutions may contain ionic monomer in an amount in a range of from 0.1 to 2.4, e.g., from 0.2 to 2.0 weight percent ionic monomer per total weight monomer solution (e.g., reactive monomers, solvent, and initiator).

Crosslinker monomer may be included in a monomer solution in a range of from 0.1 to 0.3 weight percent crosslinker monomer per total weight monomer solution (e.g., reactive monomers, solvent, and initiator).

A monomer solution may contain relative amounts of ionic monomer and crosslinker monomer as desired to produce an ionic polymer coating having membrane properties and filtering performance properties as described. Examples of useful relative amounts of ionic monomer to crosslinker monomer may be from 6.2 millimole (mmol)/liter to 148 mmol/liter ionic monomer per mole crosslinker monomer.

A monomer solution can include an amount of solvent that is useful as a liquid carrier for the reactive monomers when applying the monomer solution to a substrate surface. Examples of useful amounts of solvent may be in a range from 10 to 60 weight percent solvent based on total weight monomer solution.

The monomer solution can contain any useful amount of initiator, such as from 0.1 to 0.3 weight percent initiator based on total weight monomer solution. Alternately, a comparable amount of initiator may be applied to a membrane substrate surface separate from the monomer solution.

### Porous Membrane Substrates

The porous polymeric membrane substrate (e.g., “porous membrane substrate,” “membrane substrate,” or “substrate” for short) can be a porous polymeric membrane of a type that is useful as a filter membrane, and that is chemically inert to the materials and steps used to form the ionic polymer coating on the surface of the substrate. A useful porous membrane may be of a type often described as an ultraporous membrane, a nanoporous membrane, a microporous membrane, etc. These porous membranes are generally effective to remove undesired contaminants (e.g., particle materials, dissolved chemical species) from a flow of liquid.

Examples of useful porous membrane substrates include membrane substrates that are commercially available and known to be useful in microfiltration applications, including membranes that are considered to be microporous, ultraporous, or nanoporous, and may have average pore sizes that below 10 microns, below 5 microns, or below 1, 0.5, 0.1, 0.05, or 0.01 microns.

A useful porous substrate may be hydrophilic or hydrophobic, fluorinated, perfluorinated, or non-fluorinated, and may be made from a wide range of polymeric materials that are known in the filtration arts as being useful to form membranes useful for microfiltration applications, including: polyamide, polyimide, polysulfone, polyether-sulfone, polyarylsulfone, polyphenylsulfone (PPSU), polyacrylate, polyester, nylon, cellulose, cellulose ester, polycarbonate, and polyolefins such as polyethylene and ultra-high molecular weight polyethylene (UHPE).

Examples of fluorinated substrates include those made of polytetrafluoroethylene (PTFE), fluorinated ethylene-propylene (FEP) copolymer, a copolymer of tetrafluoroethylene and perfluoropropyl vinyl ether (PFA, also referred to as a perfluoroalkoxy polymer), a copolymer of tetrafluoroethylene and perfluoromethyl vinyl ether (MFA), and polymer compositions comprising any of these.

Specific examples include polytetrafluoroethylene, fluorinated ethylene-propylene copolymer, or perfluoroalkoxy polymer, such as those generally known as fluorocarbons marketed by E. I. Dupont de Nemours and Company, Inc. under the names Teflon® PTFE, Teflon® FEP and Teflon® PFA or amorphous forms of Teflon® polymers such as Teflon® AF polymer. Other useful fluorocarbons include those available from Daikin such as Neoflon®-PFA and Neoflon®-FEP, or various grades of Hyflon®-PFA and Hyflon®-MFA available from Solvay Solexis. Still other useful fluoropolymers include homopolymers and copolymers comprising monomeric units derived from fluorinated monomers such as vinylidene fluoride (VF2), hexafluoropropene (HFP), chlorotrifluoroethylene (CTFE), vinyl fluoride (VF), trifluoroethylene (TrFE), and tetrafluoroethylene (TFE), among others, optionally in combination with one or more other non-fluorinated monomers.

A porous membrane substrate can be described with reference to one or more properties of the substrate (“substrate properties”) as measured before the polymer coating is applied to the substrate surface. Example substrates as described can be characterized by physical features that include thickness, pore size, bubble point, porosity, and flow rate (which may be measured by “flow time”).

Porous membrane substrates can have any useful thickness, e.g., from about 5 to about 180 microns.

### Bubble Point

A bubble point measurement is based on the premise that for a particular fluid and pore size with constant wetting of a membrane, the pressure needed to force an air bubble through pores of a porous substrate is in inverse proportion to the size of the pore. A Porosimetry Bubble Point test method measures the pressure required to push air through the wet pores of a membrane. A bubble point test is a well-known method for determining the pore size of a membrane. One example of a useful bubble point test is presented herein.

Example porous membrane substrates, before an ionic polymer coating is applied to the substrate, may have a bubble point in the range of from about 2 psi to 200 pounds per square inch (psi), or from about 4 psi to about 180, or from about 4 psi to about 160 psi, when ethoxy-nonafluorobutane (HFE-7200) is used as the wetting solvent, and at a temperature of 22° C.

### Pore Size

Alternatively, pore size can be measured by known techniques such as by Mercury Porosimetry (MP), Scanning Electron Microscopy (SEM), Liquid Displacement (LLDP), or Atomic Force Microscopy (AFM).

A porous membrane substrate, before an ionic polymer coating is applied, may have any pore size that will allow the filter membrane to be effective for performing as a filter membrane. In some embodiments a porous membrane substrate can have an average pore size in a range of from about 0.001 microns to about 5 or 10 microns (1 nanometer to about 5,000 or 10,000 nanometers (nm)), e.g., from 0.01 to 0.8 microns (from 10 nanometers to 800 nanometers). A useful average pore size can be selected based on one or more factors that include: fluid flow rate, pressure, pressure drop considerations, viscosity considerations, the amounts and types of impurities (e.g., metal ions) that are present liquid (e.g., purified water) to be treated.

Useful or preferred porous membrane substrates may be considered to have relatively uniform pore sizes resulting from a higher degree of pore symmetry, or membranes with non-uniform pore sizes resulting from pore asymmetry. Pores can be isotropic or anisotropic, skinned or unskinned, symmetric or asymmetric, and any combination of these.

### Porosity

A porous membrane substrate may have any porosity that will allow the substrate filter layer to be effective as described herein. Example substrates can have a relatively high porosity, for example a porosity of at least 60, 70 or 80 percent. As used herein, and in the art of porous bodies, a “porosity” of a porous body (also sometimes referred to as void fraction) is a measure of the void (i.e., “empty”) space in the body as a percent of the total volume of the body and is calculated as a fraction of the volume of voids of the body over the total volume of the body. A body that has zero percent porosity is completely solid.

### Flow Time

Flow rate of an uncoated porous membrane substrate (substrate flow rate) can be measured as “flow time” (substrate flow time) which is an inverse of the flow rate. Flow time is defined as the time required to pass 500 milliliters of fluid (in this case deionized water) through a porous membrane with a surface area of 13.8 cm² at 14.2 psi. A flow time of an uncoated porous membrane substrate measured using deionized water may be in a range of about 100 seconds/14.2 psi/500 milliliters (s/psi/ml) to about 300 s/psi/ml.

### Methods of Preparing Coated Porous Membranes

According to methods as described, a monomer solution can be applied to a membrane substrate by steps that, compared to other methods of applying coatings to porous membrane substrates, are effective to achieve a reduced negative impact (reduction) on the flow rate of fluid through the membrane, while still providing an ionic polymer coating that has effective or even improved filtration properties when removing metal ions from water.

According to these methods, a monomer solution is first applied to a substrate surface. A monomer solution can be applied by any method that will cause the monomer solution to saturate the porous membrane substrate and to preferably contact and adhere to (wet) all surfaces of the porous membrane substrate, including all pores of the membrane substrate, to place the monomer solution at all internal and external porous surfaces of the substrate.

A monomer solution that is coated onto the substrate surface can then be dried to remove solvent from the monomer solution and to form a dried monomer coating at the substrate surface. The dried monomer coating includes the monomers of the monomer solution, initiator (which may be applied with a monomer solution or separately), and a reduced amount of the solvent. For example, at least 90, 99, or 95 percent of the solvent can be removed from the monomer solution to form the dried monomer coating. The step of drying the monomer solution can be performed by any useful method, such as by exposing the monomer solution to elevated temperature for a time sufficient to remove substantially all of the solvent from the monomer solution and leave the monomers at the surface as a dried monomer coating. Drying at room temperature with pressurized gas can be effective, or drying may be performed in an oven at a temperature that does not cause degradation of the polymer or substrate, e.g., up to about 100 degrees Celsius. Solvent that remains with the dried monomer coating may interfere with forming a polymer coating on the membrane surface. A drying step that removes essentially all solvent from the monomer solution may be useful in producing a coated membrane having a high charge density.

After the monomer solution is dried to form the dried monomer coating, the dried monomer coating is then wetted (or “re-wetted”) with solvent (a “wetting solvent”) that is effective to place the monomers within a liquid medium (the wetting solvent) in which the monomers are sufficiently chemically mobile to allow the monomers to react and polymerize, while maintaining the location of re-wetted monomers at the surface as a “re-wetted monomer coating” that is capable of being polymerized to form the ionic polymer coating at the surface.

A wetting solvent that can be used to re-wet the dried monomer coating and a technique used to apply the wetting solvent to the dried monomer can be effective to re-wet the dried monomer coating to facilitate a polymerization reaction between the monomers, for example to provide a liquid medium at the surface within which the reactive monomers are sufficiently chemically mobile to be reacted and polymerized. Also, the wetting solvent and the manner of application of the wetting solvent to the dried monomer coating should not allow or cause a significant amount of the monomer to be removed by the wetting solvent from the substrate surface. A useful wetting solvent and a useful technique of applying the wetting solvent to the dried monomer coating can be selected to achieve these effects.

A useful wetting solvent can be any solvent that, based on surface tension of the solvent and surface energy of the substrate, is capable of effectively wetting a surface of a particular polymeric filter membrane substrate. The wetting solvent should also effectively wet or mobilize the dried monomer coating to an extent that reactive monomers are capable of reacting with other reactive monomers to form the ionic polymer coating at the surface. A wetting solvent should not significantly interfere with the ability of the monomers to be chemically reacted to form a polymer coating, should not cause chemical degradation of a reactive monomer or a polymeric membrane substrate surface, and should not cause a substantial amount of reactive monomers to be removed from the substrate surface.

Different wetting solvents may be useful with different combinations of polymeric substrate and reactive monomers. For certain substrates such as those that contain polyphenyl sulfone or polyfluoroethylene, examples of useful wetting solvents include: polysiloxanes such as decamethyl tetra siloxane; perfluorinated polyethers (PFPE) (e.g., commercially available as Galden® 135HT); alkylene glycols such as hexylene glycol and dipropylene glycol; fluorinated glycol ethers such as triethylene glycol monobutyl ether, among others. In addition to these example wetting solvents used with these porous polymeric substrates, other organic solvents will be capable of performing as wetting solvents as described with particular reactive monomers and with particular porous polymeric membrane substrates.

After re-wetting the monomers of the dried monomer coating to form the re-wetted monomer coating, the monomers of the re-wetted monomer coating can be reacted (polymerized) by exposing the re-wetted monomer coating to electromagnetic radiation that is effective to cause the initiator to cause the reactive monomers to polymerize and form the ionic polymer coating.

The ionic polymer coating, after the polymerization step, may be further processed by steps of removing the wetting solvent or un-reacted reactive monomer from the ionic polymer coating. For example, one or more chemical extraction steps may be performed by which the ionic polymer coating is contacted with solvent to remove wetting solvent, un-reacted monomers, or both. The coated membrane may then be dried if necessary, and the resulting coated porous polymeric filter membrane may be subsequently processed to convert the coated membrane into a filter membrane of a filter product.

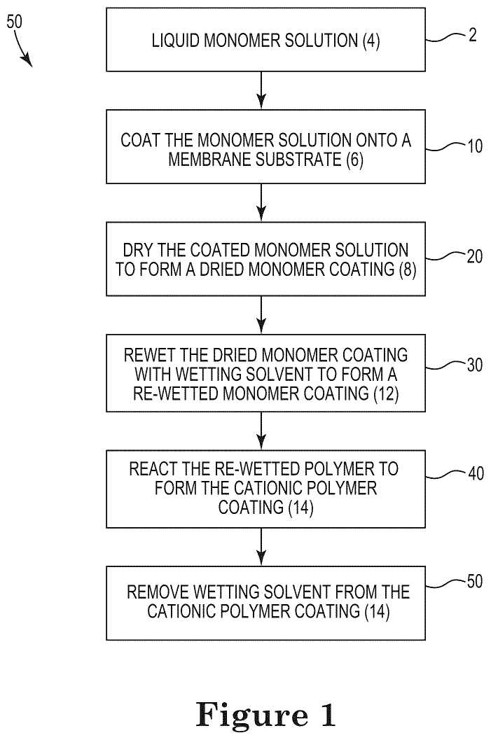

An example method 200 is shown schematically as a block diagram at FIG. 1. Initially (2), monomer solution 4 is prepared or provided, and the monomer solution is applied by coating (10) onto membrane substrate 6. Monomer solution 4 may be applied using any effective method and equipment, such as any one or more of a mechanical coating or impregnation technique, to coat external and internal pore surfaces of the porous membrane substrate 6. Coating operation 10 may be performed in a batch or semi-batch process but may preferably be performed in a continuous manner by applying monomer solution 4 onto a moving web of porous membrane substrate 6. Effective techniques used alone or in combination may include: spraying, roller coating, submersion by continuously passing a moving web of the membrane substrate 6 through a bath of monomer solution 4. A coating operation 10 may be performed at any useful conditions and temperature, for example with monomer solution 4 having a temperature in a range of ambient temperature.

After coating operation 10, and before a subsequent crosslinking (or “polymerization”) operation 40, solvent of monomer solution 4 is dried (20) to form a dried monomer coating 8 at the substrate surface. The dried monomer coating 8 is then re-wetted (30) with wetting solvent to form re-wetted monomer coating 12 at the surface of membrane substrate 6.

In crosslinking operation 40, the substrate 6 having the re-wetted monomer coating 12 at the surface can be polymerized by exposure to electromagnetic radiation. The substrate 6 with the re-wetted monomer coating 12 can be passed continuously through a chamber that is illuminated with electromagnetic radiation, e.g., ultraviolet radiation, having a wavelength and intensity to cause desired crosslinking of the reactive monomers of the re-wetted monomer coating and to thereby form polymer coating 14 at the substrate surface. The crosslinking operation 40 can be performed at any useful conditions and temperature. To avoid thermal degradation of a membrane substrate that may be temperature-sensitive, if used, an interior of a crosslinking chamber (“UV chamber”) can be maintained at a temperature that does not allow the membrane substrate to reach a temperature above than 170, 150, or 120 degrees Celsius.

After the re-wetted monomer coating has been exposed to radiation to cause reactive monomers to be crosslinked and form polymer coating 14, subsequent steps can be performed to remove wetting solvent or un-reacted reactive monomer from polymer coating, to dry the coating, and to convert the resultant coated membrane into a filter product.

As an example, a coated membrane having an ionic polymer coating at the surface may be processed by one or more chemical extraction steps 50 to remove un-reacted, excess chemical ingredients from the polymer coating. Extraction may be performed with any useful extraction solvent such as water (e.g., deionized water), an organic solvent (e.g., isopropyl alcohol) (“extraction solvent”), or a combination of these, in a single step or in a series of two or more steps that each may use the same or a different liquid (e.g., solvent or water).

An extraction step may be performed at ambient temperature, e.g., below 40, 30, or 25 degrees Celsius, or at an elevated temperature. The extraction solvent can be caused to contact the coated membrane by spraying, by submersing the coated membrane in the extraction solvent, and with optional mechanical agitation such as by the use of pressure, e.g., from rollers, a squeegee, or the like. Effectively, with one or more extraction steps, a large portion of excess ingredients or remaining wetting solvent can be removed from the ionic polymer coating.

After an extraction step, e.g., 50, the coated membrane may be dried to remove the extraction solvent from the surface and from the polymer coating. A drying step can be performed by exposing the coated membrane (after extraction) to an elevated temperature for a time sufficient to remove residual extraction solvent, e.g., by passing the coated membrane through an oven or a heated chamber that contains a heated environment. To avoid thermal degradation of a heat-sensitive membrane substrate, if used, the temperature of the heated environment can be in a range that does not allow the substrate to reach a temperature at which thermal degradation would occur as the substrate moves through the heated environment, e.g., the environment may be at a temperature that does not exceed 170, 150, or 120 degrees Celsius.

A coated porous polymeric membrane that is formed on a membrane substrate by a method as described herein can have filtering performance properties that include a relatively high flow rate (a relatively low flow time) and high retention of metal ions when used to remove metal ions from purified water.

A flow time of deionized water through a coated membrane (a “coated membrane flow time”) can be measured as the time it takes to pass 500 milliliters of fluid (in this case deionized water) through the coated membrane with a surface area of 13.8 cm² at 14.2 psi. The coated membrane flow time will be increased relative to a flow time of the substrate used to prepare the coated membrane (“substrate flow time”), due to the presence of the polymer coating. The increase in flow time will be comparatively less than an increase in flow time of a coated membrane prepared by alternate methods that do not include a step of drying the monomer solution to form a dried monomer coating, and re-wetting the monomer coating, before polymerizing the reactive monomers.

According to useful and preferred methods and coated membranes, a deionized water flow time of a coated membrane (coated membrane flow time) may be increased by not more than 50, 40, 30, or 20 percent compared to a deionized water flow time of the uncoated substrate (substrate flow time) of the coated membrane. Example coated membranes may have a deionized water flow time of less than 400 seconds/14.2 psi/500 milliliters (s/psi/ml), e.g., less than 300 s/psi/ml, or in a range from 100 to 200 s/psi/ml.

According to useful and preferred methods, a coated membrane may have a dye binding capacity of at least 5 μg/cm².

### Filters/Filter Devices

A coated membrane can be contained within a larger filter structure such as a filter or a filter cartridge that is used in a filtering system. The filtering system will place the coated membrane, e.g., as part of a filter or filter cartridge, in a flow path of purified water to cause the purified water to flow through the coated membrane and allow the coated membrane to remove metal ions from the flow of purified water. The structure of a filter or filter cartridge may include one or more of various additional materials and structures that support the coated membrane within the filter product to cause purified water to flow from a filter inlet, through the coated membrane, and thorough a filter outlet, thereby passing through the coated membrane when passing through the filter product. The coated membrane supported by the filter product can be in any useful shape, e.g., a pleated cylinder, cylindrical pads, one or more non-pleated (flat) cylindrical sheets, a pleated sheet, among others.

The coated membrane may be used in combination with a second filter membrane to provide a combination of filtering retention of different types of metal ions or other contaminants. As an example, the coated membrane may be used in series with a second filter membrane in the form of a non-woven polymeric membrane that is made of a useful filtering material, e.g., polyolefin fibers such as high-density polyethylene, polysulfonic acid, among others. The non-woven membrane may be surface-modified (e.g., “functionalize”) to include a negative charge at the membrane surface to improve retention of metal ions. Examples of useful non-woven membranes include those sold under the trade name Tyvex, which are membranes that include negatively-charged sulfonic acid groups.

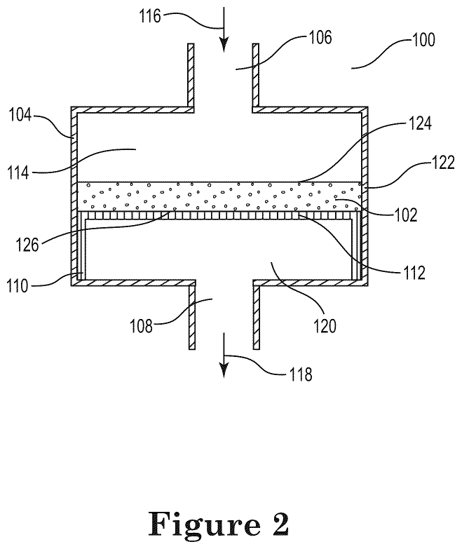

An example of a useful filter device and a method of removing metal ions from water is shown at shown at FIG. 2. Filter 100 includes a coated porous polymeric membrane 102, which includes a membrane substrate and an ionic polymer coating as described. Filter 100 can have a housing 104 that provides a structure to the filter 100 and that fluidically seals an internal portion of the filter. The housing 104 can be any shape and size, such as cylindrical, polygonal, etc.

One portion of the housing 104 includes inlet port 106 to receive a purified water to be filtered. The purified water can flow through inlet port 106 in the direction indicated by arrow 116, and into a headspace 114 in the filter 100, as defined by an input-facing surface 124 of coated membrane 102, the internal surface of the housing 104, and the inlet port 106.

One portion of the housing 104 includes outlet port 108 to allow filtered purified water to exit from filter 100. The filtered purified water can flow in the direction indicated by arrow 118 through outlet port 108 from backspace 120, as defined by an output facing surface 126 of coated membrane 102, the internal surface of the housing 104, and the outlet port 108.

The interior of filter 100 can contain coated membrane 102 in any suitable placement or arrangement, with FIG. 2 showing coated membrane 102 having a disc-like form (a cross-sectional view is shown). A side 122 of the porous polymeric membrane 102, such as the outer circumference of the membrane, can be in contact with the inner surface of the housing 104. Coated membrane 102 can also have an input-facing surface 124, which first contacts the purified water, and an output-facing surface 126, from which the filtered purified water with reduced amounts of metal ions flows.

Filter 100 can also include one or more structures to support the coated membrane 102 within the filter housing. Any arrangement for supporting coated membrane 102 can be used and can include one or more distinct structural features, such as a frame, frame, bracket, clip, web, net, and cage, and the like, or a material such as an adhesive can be used to support the membrane.

As illustrated, with reference to FIG. 2, the filter 100 includes a frame having frame portions 110 and 112, with frame portion 110 in contact with the interior of housing 104, which is attached to portion 112. Portion 112 can be in contact with the output-facing surface 124 of the porous polymeric membrane 102 and can provide support to the membrane during filtering. Frame portion 112 can have a grid-like structure to freely allow filtered liquid to pass into the backspace 120 of the filter, while still providing structural support to the polymeric porous membrane under increased fluidic pressures.

In use, a purified water enters filter 100 through inlet port 106 in direction indicated by arrow 116, and then fills the headspace 114 within the filter 100. Sufficient fluidic pressure is applied to cause the fluid to move through the porous polymeric membrane at a desired flow rate.

### EXAMPLES

### Example 1: Porosimeter Bubble Point (“HFE Mean BP”)

A porosimetry bubble point (“HFE Mean BP” in the tables below) test method measures the pressure required to push air through wet pores of a porous membrane. A bubble point test is a well-known method for understanding the pore size and/or pore size distribution of a membrane.

The present example describes the porosimetry bubble point test method that is used to measure the pressure required to push air through the wet pores of a membrane. For exemplary membranes presented herein, the test was performed by mounting a 47 mm disk of a dry membrane sample in a holder. The holder is designed in a way to allow the operator to place a small volume of liquid on the upstream side of the membrane. The dry air flow rate of the membrane was measured first by increasing the air pressure on the upstream side of the membrane to 160 psi. The pressure is then released back to atmospheric pressure and a small volume of ethoxy-nonafluorobutane (available as HFE 7200, 3M Specialty Materials, St. Paul, Minn., USA) was placed on the upstream side of the membrane to wet the membrane. The wet air flow rate was then measured by increasing the pressure again to 160 psi. The bubble point of exemplary membranes was measured from the pressure required to displace HFE from the pores of the HFE-wet membranes. This critical pressure point is defined as the pressure at which a first non-linear increase of wet air flow is detected by the flow meter.

### Example 2: Dye Binding Capacity (“DBC”) Test

The present example demonstrates measuring dye binding capacity for quantifying functional groups and/or the amount of charge on exemplary coated membranes in accordance with the present disclosure. Dye Binding Capacity is typically presented in the units of μg/cm². For comparative purposes, unmodified membranes typically show a dye binding capacity of less than 0.3 μg/cm². In some cases, Dye Binding Capacity Tests can be useful in quantifying negative charge, for example by using Methylene Blue Dye. In some cases, Dye Binding Capacity Tests can be useful in quantifying positive charge, for example by Ponceau S Red Dye.

### Example 2A: Negative Charge Dye Binding Capacity (“DBC”) Test Using Methylene Blue Dye

The present example demonstrates that methylene blue dye was used to identify negative charge on a membrane surface. Methylene blue dye is cationic in nature and binds to negatively-charged coated membranes. Thus, the present example is useful for characterizing exemplary negatively-charged membranes presented herein.

For exemplary membranes presented herein, a dry 25 mm disk membrane was cut from a coated negatively-charged membrane sheet and was pre-wetted with isopropyl alcohol, rinsed with DI water, and placed on a 50 ml vial containing 0.00075 wt % methylene blue dye (available from Sigma) in DI water. When membranes were tested using a negative charge dye binding capacity test, membrane disks were soaked for 2 hours with continuous mixing at room temperature. Membrane disks were then removed and the absorbance of the dye solution was measured using a Cary spectrophotometer (Agilent Technologies) operating at 660 nm.

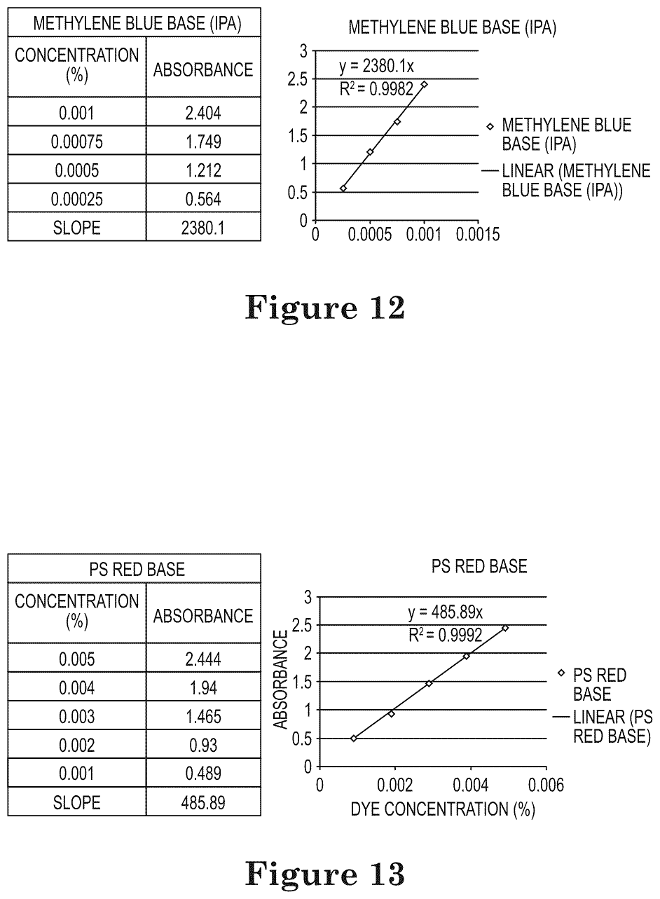

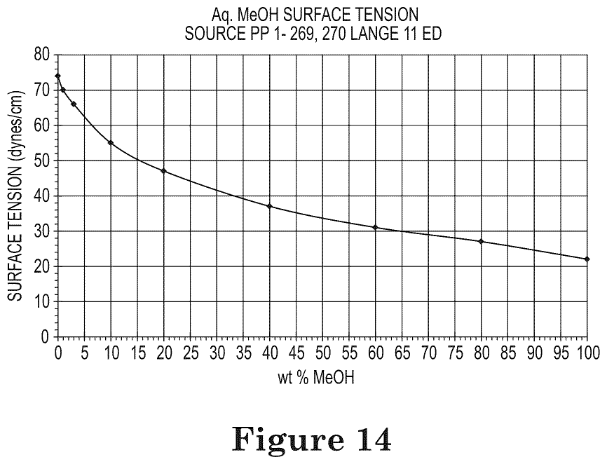

A calibration curve showing the absorbance of four methylene blue dye solutions with known concentrations determined using a Cary Spectrophotometer operating at 660 nm wavelength (γ=2380.1x) is presented in FIG. 12. The slope of the calibration curve presented in FIG. 12 was used to convert dye solution absorbance data before and after soaking disclosed exemplary membranes, to weight percent dye, which was then converted to the mass of dye bound per membrane unit area.

### Example 2B: Positive Charge Dye Binding Capacity Test Using Ponceau S Red Dye

Ponceau S Red Dye is used to distinguish positive charge on a membrane substrate surface. The dye is anionic in nature and binds to positively-charged coated membranes. Thus, the present example is useful for characterizing exemplary positively-charged membranes presented herein.

A dry 25 mm disk membrane was cut from a coated positively charged membrane sheet, was pre-wetted with isopropyl alcohol, rinsed with DI water, and placed on a 50 ml vial containing 0.0025 wt % Ponceau S Red dye (available from Sigma) in DI water.

The positively-charged membrane disks were soaked for 2 hours with continuous mixing at room temperature. The positively-charged membrane disks were then removed, and the absorbance of the dye solution was measured using a Cary spectrophotometer (Agilent Technologies) operating at 520 nm and compared to the absorbance of starting solution (before membrane soaking). A calibration curve showing the absorbance of four Ponceau S Red dye solutions with known concentrations determined using a Cary Spectrophotometer operating at 520 nm wavelength (γ=485.89 x) is presented in FIG. 13. The slope of the calibration curve depicted in FIG. 13 was used to convert dye solution absorbance data before and after soaking positively charged membranes to weight percent dye, which was then converted to the mass of dye bound per membrane unit area.

### Example 3: Methanol (“MeOH”)/DIW Wettability

Wettability test is useful in characterizing coated membranes' surface energy. The composition of the liquid used to wet the surface of the membrane may be correlated with the surface energy in dynes/cm² of exemplary coated membranes.

To perform the test for coated membranes disclosed herein, mixtures were prepared of various weight percentages of methanol and water using a balance. A drop of these MeOH/water solutions were applied to a 47 millimeter disc sample of exemplary coated membranes. Coated membranes were characterized as being wettable if tested exemplary membranes changed from opaque to translucent in 5 seconds or less. This indicates that the tested membrane was wet with the MeOH/water solution with the solution. If wetting of the microporous membrane composite sample does not occur for a certain MeOH/water solution, another solution containing a greater amount of MeOH was then used to determine wettability. If wetting does occur, a solution containing a lesser amount of MeOH was used. Various solutions containing methanol and water were used to evaluate coated membranes as described.

Coated membranes prepared by methods as presented herein, that include steps of drying and re-wetting monomer solution before polymerizing, can exhibit improved wettability relative to comparable coated membranes prepared without the drying and re-wetting steps.

### Example 4: Positively Charged, Coated Membranes

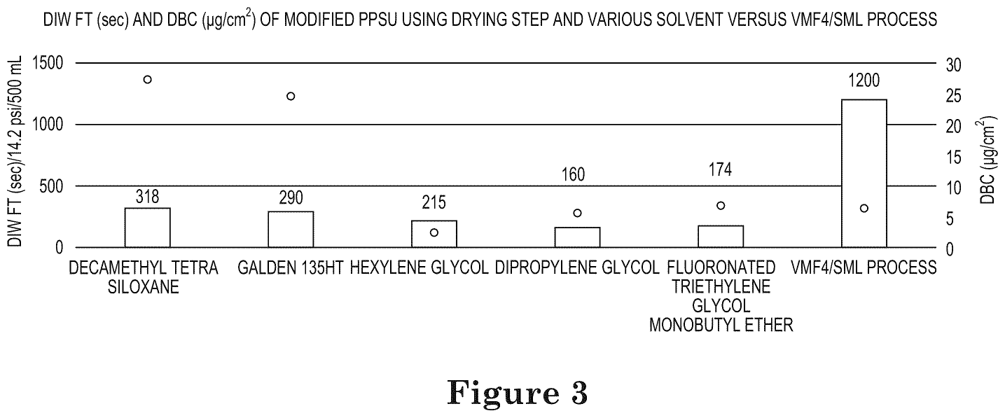

Example positively-charged membranes were prepared as follows and tested for flow time performance, with results presented in FIG. 3.

Uncoated membranes were immersed in formulation mixture including 0.2 wt % Irgacure2959, 0.2 wt % of 65 wt % DADMAC, 0.2 wt % MBAM, 60 wt % MeOH, and 39 wt % water for 1 min/60 sec, which were then dried in an oven at 60° C. for 1 hour. After drying, they were then rewet in Galden 135HT, Galden GT 80, hexylene glycol, dipropylene glycol, fluorinated triethyl glycol, or decamethyltetrasiloxane. These re-wet membranes were placed between polyethylene films and subsequently squeezed to remove trapped air. Following squeezing, they were then exposed to UV radiation, at a line speed of about 10 ft/min. Extract modified membrane in IPA followed by: water extraction, IPA extraction, oven dry.

As presented in this example, VMF4/SML refers to a coating prepared from the same formulation mixture and an otherwise comparable process, but that does not include the drying step and re-wetting steps before polymerization.

Results at FIG. 3 shows that flow times of positively charged membranes modified (coated) using drying and re-wetting steps with various rewetting solvents were significantly lower compared to the flow time of the “VMF4/SML” membranes prepared using an otherwise comparable coating process that does not involve the drying and re-wetting steps.

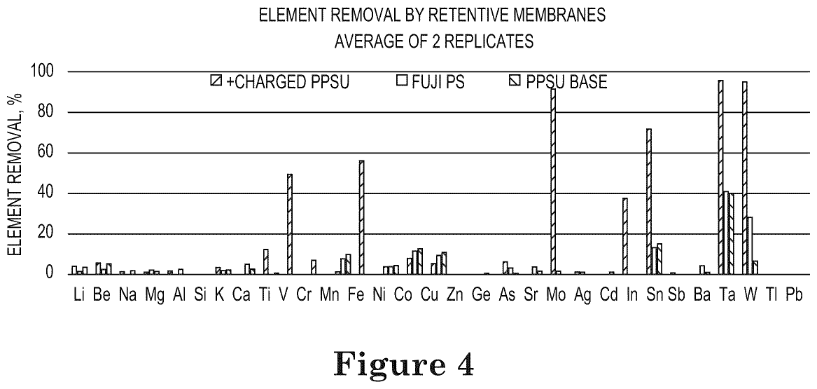

With reference to FIG. 4, a PPSU (polyphenylsulfone) substrate, a positively charged PPSU coated membrane, and a Fuji Polysulfone membrane discs were prewetted in isopropyl alcohol, rinsed with DIW, and immersed in a 1.4 ppb concentration of 29 element standard at room temperatures, for a total of 16 hours.

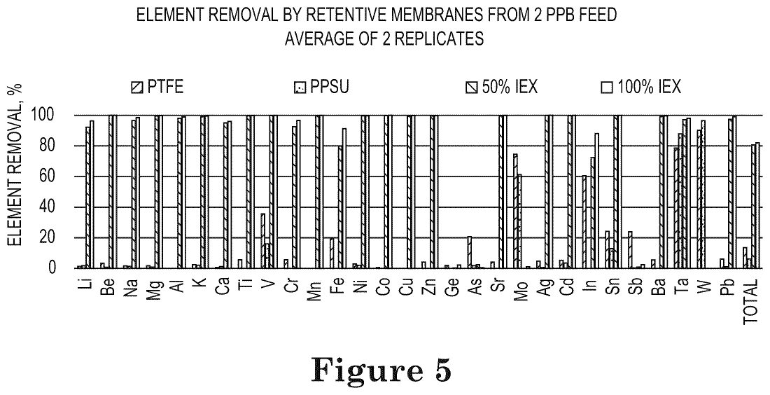

ICPMS analysis of the solution before and after soaking indicated that the positively charged coated PPSU membrane removed notable amounts of V, Mo, Sn, Ta and W as shown at FIG. 4. However, Mo and W, which are in process metals are not removed well by the IEX membranes as shown in FIG. 5.

Referring to FIG. 5, positively charged (coated) PPSU (“PPSU”) and positively charged (coated) PTFE (“PTFE”) membranes and 100% and 50% IEX media discs were prewetted in isopropyl alcohol, rinsed with DIW, and immersed in a 2 ppb concentration of 29 element standard at room temperatures for a total of 16 hours. ICPMS analysis of solution before and after soaking indicated that IEX membranes remove all elements well (>90%) except Ge, As, Mo, In, Sb and W, and positively charged PPSU labeled in FIG. 5 “PPSU” (positively-charged coated membrane) removes notable amounts of V, Mo, Sn, Ta and W. The positively-charged coated PTFE membrane also removes notable amount of V, As Mo, In, Ta and W, as also shown in FIG. 5.

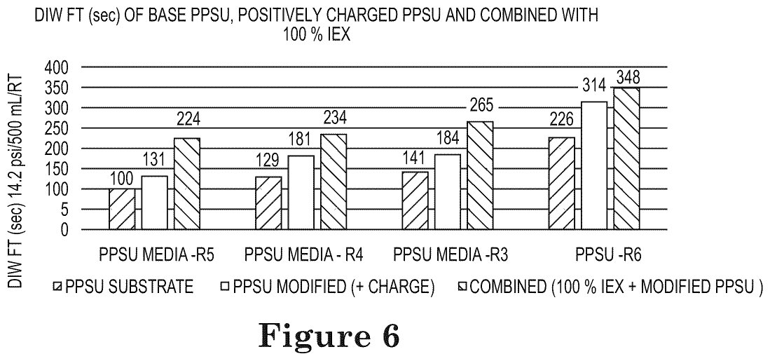

Exemplary coated PPSU membranes having different initial bubble points were prepared as follows, and tested, with performance information shown at FIG. 6. PPSU membrane sheets (10×4 inch) were immersed in a formulation mixture of 0.2% wt DADMAC, 0.15% Wt MBAM, 0.2% wt Irgacure, 60% methanol and 39.5% DIW for 60 sec. These membrane sheets were dried in an oven at 60° C. for 1 hour, followed by rewetting in Galden 135HT. These re-wetted membranes were then placed between polyethylene films and squeezed using a roller to remove the air. These sandwiched membranes were then exposed to UV radiation, at a line speed of 10 ft/min, followed by extraction in isopropyl alcohol, then DIW extraction, and then a second isopropyl alcohol extraction to remove unreacted monomer. These membranes were then dried in an oven at 60° C.

Presented in in FIG. 6 is DIW FT in seconds of a PPSU substrate and positively charged media, as well as a comparison to positively charged PPSU combined with 100 percent IEX. Four sample PPSU substrates of different initial bubble points are identified as R3, R4, R5, and R6.

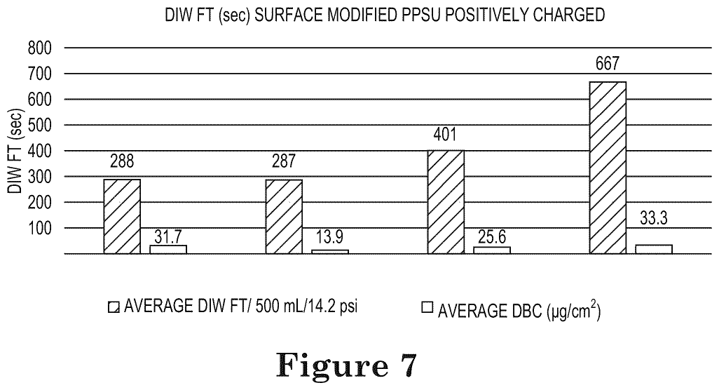

Sample coated membranes were prepared as follows, and tested, with performance information shown at FIG. 7. PPSU membrane sheets (10×4 inch) were immersed in in formulation mixtures that contain different amounts of DADMAC (0.2, 0.2, 0.26, and 0.325 weight percent) for 60 sec. These membrane sheets were then dried in an oven at 60° C. for 1 hour, followed by rewetting the membranes in Galden 135HT. Re-wetted membranes were then placed between polyethylene films, and squeezed using a roller to remove the air. These membranes sandwiched between polyethylene film sheets were exposed to UV radiation, at a line speed of 10 ft/min, followed by extraction in isopropyl alcohol, then DIW extraction and a second isopropyl alcohol extraction to remove unreacted monomer. These membranes were then dried for 45 min at RT and 15 min in oven at 60° C.

Shown in FIG. 7 is the effect of DADMAC concentration in DIW FT and dye binding capacity of positively charged PPSU membranes.

### Example 5: Negatively Charged, Coated Membranes

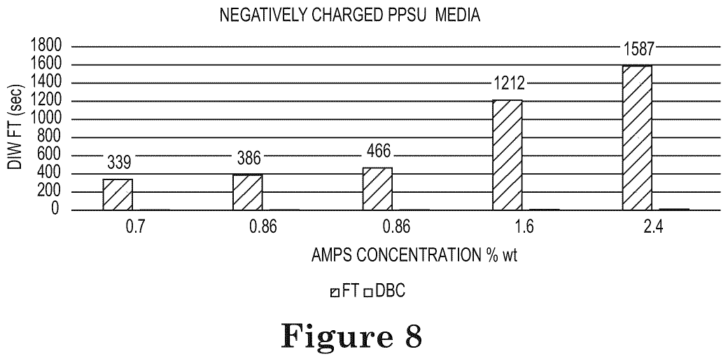

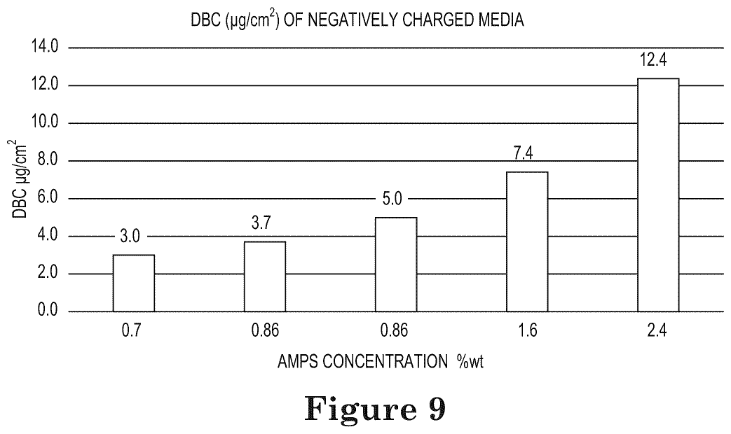

Sample coated membranes were prepared as follows to produce a negatively charged retentive layer media without a drying and re-wetting step, and tested, with performance information shown at FIGS. 8 and 9.

PPSU membrane sheets (10×4 inch) were immersed in formulation mixtures listed in Table 1 for 60 seconds. These membranes were then placed between polyethylene films and squeezed using a roller to remove all the air. Membranes sandwiched between the polyethylene film sheets were exposed to UV radiation, at a line speed of 10 ft/min followed by extraction in isopropyl alcohol, then DIW extraction, and then a second isopropyl alcohol extraction to remove unreacted monomer. These membranes were then dried in an oven at 60° C. The DIW flow time of PPSU substrate was measured to be 230 seconds.

TABLE 1
Formulation Mixtures and Membrane Attributes

| | | | | | Modified Membrane Attributes | |
|---|---|---|---|---|---|---|
| Formulation % wt | | | | | Avg DIW | DBC |
| IRG | AMPS | MBAM | MeOH | WATER | FT (sec) | (μg/cm²) |
| 0.15 | 0.7 | 0.15 | 10 | 89 | 339 | 3 |
| 0.15 | 0.86 | 0.17 | 10 | 89 | 386 | 3.7 |
| 0.15 | 0.86 | 0.15 | 10 | 89 | 466 | 5.0 |
| 0.15 | 1.6 | 0.3 | 10 | 88 | 1212 | 7.4 |
| 0.15 | 2.4 | 0.45 | 10 | 87 | 1587 | 12.4 |

FIG. 8 shows DIW FT of the negatively charged retentive layer media made with no drying or rewetting step. At AMPS concentrations of 0.7 and 0.86, flow rate reductions using this process, not including a drying and re-wetting step, were 47 percent and 67 percent.

FIG. 9 shows dye-binding capacity of the negatively charged retentive layer media made with no drying or rewetting step.

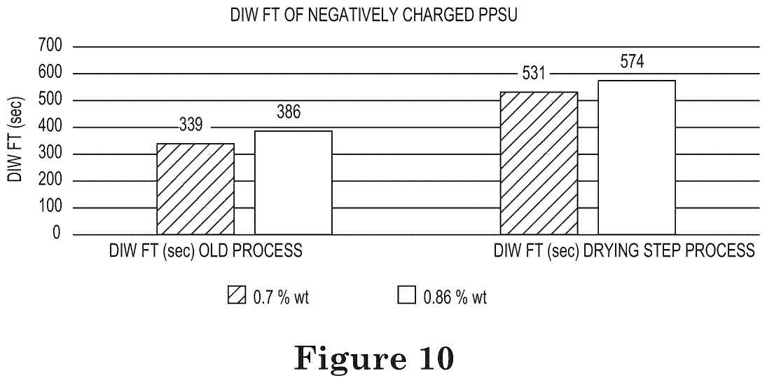

Sample coated membranes were prepared as follows to produce a negatively charged coated retentive layer media by a process that includes a drying and re-wetting step as described, and tested, with performance information shown at FIG. 10.

PPSU membrane sheets (10×4 inch) were immersed in a formulation mixture listed in Table 2 below. Membrane sheets were dried in an oven at 60° C. for 1 hour followed by prewetting membrane in Galden 135HT. These Wetted membrane were then placed between polyethylene films and squeezed using a roller to remove the air. Membranes sandwiched between polyethylene film sheets were then exposed to UV radiation, at a line speed of 10 ft/min, followed by extraction in isopropyl alcohol, then DIW extraction, and a second isopropyl alcohol extraction to remove unreacted monomer. These membranes were then dried in an at 60° C.

FIG. 10 and Table 2 show DIW FT and dye-binding capacity of the negatively charged retentive layer media made using a drying and rewetting step before polymerization.

TABLE 2
Formulation Mixtures and Membrane attributes of Negatively Charged PPSU

| | | | | | | Modified | |
|---|---|---|---|---|---|---|---|
| | | | | | PPSU Sub | | % |
| Formulation | | | | | Avg DIW | Avg DIW | Increase |
| IRG | AMPS | MBAM | MeOH | WATER | FT (sec) | FT (sec) | in FT |
| 0.15 | 0.86 | 0.17 | 60 | 38.8 | 230 | 531 | 131 |
| 0.15 | 0.7 | 0.15 | 60 | 38.8 | 230 | 574 | 149 |

### Example 6: G25 nm Retention of Positively Charged PPSU Versus PPSU Substrate and Fuji PS 20 nm Membranes

After inserting the coupon sample of coated membrane on a holder and prewetting with IPA, water was flushed through the coupon holder for 5 minutes, followed by blank solution flushing through the upstream and collection after 200 ml has passed. The flowrate was set at (30 ml/min for 90 mm coupons) by adjusting the pressure in the coupon holder and measuring the amount of blank that flows through the downstream. In the next step, the feed was flushed through the upstream, and a feed sample is collected after 200 ml has passed. Samples were collected after each monolayer percentage has been achieved. For G25 nm retention tests, blanks were either DIW or DIW with surfactant. The feed consisted of DIW and G25 test particles, with or without surfactant. Data were collected after 44 ml (0.5% monolayer), 44 ml (1% monolayer), and 88 ml (2% monolayer) has passed through the membrane downstream.

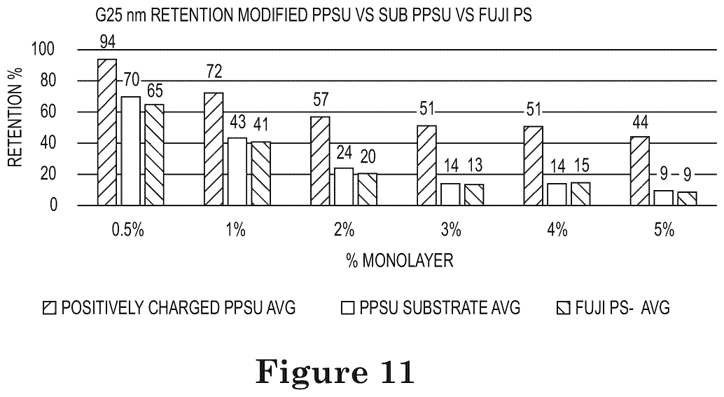

As shown at Table 3 and at FIG. 11, a membrane (PPS) that includes a positively charged coating applied by a method as described herein can exhibit improved filtering retention performance relative to alternate non-coated membranes.

TABLE 3
Particle Retention Data

| ID | Retention % | | | | | |
|---|---|---|---|---|---|---|
| % Monolayer | 0.5% | 1% | 2% | 3% | 4% | 5% |
| Positively Charged (coated) | 94 | 72 | 57 | 51 | 51 | 44 |
| PPSU - Avg | | | | | | |
| PPSU Substrate - Avg | 70 | 43 | 24 | 14 | 14 | 9 |
| Fuji PS - Avg | 65 | 41 | 20 | 13 | 15 | 9 |

### Example 7: Flow Penalty and Charge Capacity

As shown at Tables 4A, 4B, 5A, 5B, 6A, and 6B when using either positively or negatively charged vinyl or acrylamide monomers and using a drying step and prewetting in Galden solvent prior to UV exposure, membranes exhibited both improvements in flow penalty and charge capacity. For the same charged monomer concentration, DBC was higher with drying and re-wetting compared to without those steps.

TABLE 4A
Exemplary Formulation Mixtures for Negatively Charged PPSU Membranes Using SVS 25

| | | | SVS 25: | | | | | |
|---|---|---|---|---|---|---|---|---|
| | | | Vinyl sulfonic | | | | | |
| Formulation | | | acid sodium | Actual | Irgacure | MBAM | MeOH | DIW |
| ID | Process | Charge | salt (% wt) | SVS | (% wt) | (% wt) | (% wt) | (% wt) |
| 1 | No Dry or | negative | 0.86 | 3.44 | 0.15 | 0.15 | 10 | 86.26 |
| | Rewet | | | | | | | |
| 2 | Dry step + | negative | 0.86 | 3.44 | 0.15 | 0.15 | 60 | 36.24 |
| | Rewet in | | | | | | | |
| | solvent | | | | | | | |
| 3 | Dry step + | negative | 0.215 | 0.86 | 0.15 | 0.15 | 60 | 38.84 |
| | Rewet in | | | | | | | |
| | solvent | | | | | | | |

TABLE 4B
Properties of Membranes in Table 4A

| | DIW FT | | | |
|---|---|---|---|---|
| Formulation | PPSU Substrate | DIW FT | % Flow | DBC |
| ID | (sec) | Modified (sec) | Reduction | (μg/cm²) |
| 1 | 134 | 211 | 57 | 1.8 |
| 2 | 134 | 266 | 99 | 17.5 |
| 3 | 134 | 182 | 36 | 4.7 |

TABLE 5A
Exemplary Formulation Mixtures for Positively
Charged PPSU Membrane Using APTAC Monomer

| Formulation | | | APTAC at | Actual | Irgacure | MBAM | MeOH | DIW |
|---|---|---|---|---|---|---|---|---|
| ID | Process | Charge | 76% wt | APTAC | (% wt) | (% wt) | (% wt) | (% wt) |
| 4 | No dry or | Positive | 0.27 | 0.36 | 0.15 | 0.15 | 10 | 89.34 |
| | rewet | | | | | | | |
| 5 | Dry step + | Positive | 0.27 | 0.36 | 0.15 | 0.15 | 60 | 39.34 |
| | rewet in | | | | | | | |
| | solvent | | | | | | | |
| 6 | Dry step + | Positive | 0.09 | 0.12 | 0.15 | 0.15 | 60 | 39.49 |
| | rewet in | | | | | | | |
| | solvent | | | | | | | |

TABLE 5B
Properties of Membranes in Table 5A

| | | | DIW FT | | |
|---|---|---|---|---|---|
| | | DIW FT PPSU | Modified | % Flow | DBC |
| Formulation ID | Process | Substrate (sec) | (sec) | reduction | (μg/cm²) |
| 4 | No dry or rewet | 134 | 220 | 64 | 2.6 |
| 5 | Dry step + rewet in solvent | 134 | 172 | 28 | 8.2 |
| 6 | Dry step + rewet in solvent | 115 | 123 | 7 | 1.5 |

TABLE 6A
Exemplary Formulation Mixtures for Negatively
Charged PPSU Membranes using AMPS Monomer

| Formulation | | | | Irgacure | MBAM | MeOH | DIW |
|---|---|---|---|---|---|---|---|
| ID | Process | Charge | AMPS | (% wt) | (% wt) | (% wt) | (% wt) |
| 7 | No Dry or | negative | 0.86 | 0.17 | 0.15 | 10 | 88.82 |
| | Rewet | | | | | | |
| 8 | Dry step + | negative | 0.286 | 0.17 | 0.15 | 60 | 39.394 |
| | rewet in | | | | | | |
| | solvent | | | | | | |

TABLE 6B
Properties of Membranes in Table 6A

| | DIW FT | DIW FT | | |
|---|---|---|---|---|
| Formulation | PPSU | modified | % Flow | DBC |
| ID | sub (sec) | (sec) | reduction | (μg/cm²) |
| 7 | 232 | 386 | 66 | 3.7 |
| 8 | 115 | 127 | 10 | 41 |

### Aspects

In a first aspect, the present disclosure relates to a coated porous polymeric membrane that is capable of removing metal ions from purified water, the coated porous polymeric membrane comprises a porous polymeric membrane substrate and an ionic polymer coating at a surface of the porous polymeric membrane substrate, wherein: the porous polymeric membrane substrate exhibits a substrate flow time measured as deionized water flow time, and a bubble point in a range from 2 to 200 pounds per square inch measured using ethoxy-nonafluorobutane, the coated porous polymeric membrane comprising the porous polymeric membrane substrate and the ionic polymer coating at a surface of the porous polymeric membrane substrate exhibits a coated membrane flow time measured as deionized water flow time, for a porous polymeric membrane substrate having a bubble point below 80 pounds per square inch, the coated membrane flow time is not more than 30 percent greater than the substrate flow time of the porous polymeric membrane substrate when it does not have an ionic polymer coating, for a porous polymeric membrane substrate having a bubble point between 80 and 140 pounds per square inch, the coated membrane flow time is not more than 40 percent greater than the substrate flow time of the porous polymeric membrane substrate when it does not have an ionic polymer coating, for a porous polymeric membrane substrate having a bubble point above 140 pounds per square inch, the coated membrane flow time is not more than 50 percent greater than the substrate flow time of the porous polymeric membrane substrate when it does not have an ionic polymer coating, and the ionic polymer coating comprises monomeric units derived from ionic monomer and crosslinker monomer.

A second aspect according to the first aspect, wherein the ionic monomer comprises di-ethylenically-unsaturated cationic monomer.

A third aspect according to any of the first or second aspects, wherein the ionic monomer comprises di-ethylenically unsaturated anionic monomer.

A fourth aspect according to any of the first through third aspects, wherein the ionic monomer comprises di-ethylenically unsaturated zwitterionic monomer.

A fifth aspect according to any of the first through fourth aspects, wherein the crosslinker monomer comprises a di-ethylenically-unsaturated monomer.

A sixth aspect according to any of the first through fifth aspects, wherein the porous polymeric membrane substrate comprises polyphenylsulfone and the coated porous polymeric membrane has a dye binding capacity of greater than 5 micrograms per square centimeter.

A seventh aspect according to any of the first through fifth aspects, wherein the porous polymeric membrane substrate comprises polytetrafluoroethylene and the coated porous polymeric membrane has a die binding capacity of greater than 50 micrograms per square centimeter.

An eight aspect according to any of the first through fifth aspects, wherein the porous polymeric membrane substrate comprises polyphenylsulfone and the coated porous polymeric membrane has a deionized water flow time of less than 400 seconds.

A ninth aspect according to any of the first through fifth or seventh aspects, wherein the porous polymeric membrane substrate comprises polytetrafluoroethylene and the coated porous polymeric membrane has a deionized water flow time of less than 400 seconds.

A tenth aspect according to any of the first through ninth aspects, wherein the coated porous polymeric membrane is characterized as removing, from purified water, at least 40 percent of one or more of the following metal ions: vanadium, iron, molybdenum, tin, tantalum, and tungsten.

An eleventh aspect according to any of the first through tenth aspects, wherein the coated porous polymeric membrane is characterized as removing, from purified water, at least 60 percent of one or more of the following metal ions: molybdenum, tin, tantalum, and tungsten.

In a twelfth aspect, the present disclosure is directed to a coated porous polymeric membrane comprising: (i) a porous polymeric membrane substrate exhibiting: (a) a substrate flow time measured as deionized water flow time, and (b) a bubble point in a range from 2 to 200 pounds per square inch measured using ethoxy-nonafluorobutane; and (ii) an ionic polymer coating at a surface of the porous polymeric membrane substrate, the ionic polymer coating comprising monomeric units derived from an ionic monomer and a crosslinker monomer; wherein the coated porous polymeric membrane exhibits a coated membrane flow time measured as deionized water flow time, the coated membrane flow time being no more than 50% greater than the substrate flow time of the porous polymeric membrane substrate when it does not have the ionic polymer coating.

A thirteenth aspect according to the twelfth aspect, wherein the porous polymeric membrane substrate has a bubble point greater than 140 pounds per square inch, and the coated membrane flow time is no more than 50% greater than the substrate flow time of the porous polymeric membrane substrate when it does not have the ionic polymer coating.

A fourteenth aspect according to the twelfth aspect, wherein the porous polymeric membrane substrate has a bubble point between 80 pounds per square inch and 140 pounds per square inch, and the coated porous polymeric membrane flow time is not more than 40% greater than the substrate flow time of the porous polymeric membrane substrate when it does not have the ionic polymer coating.

A fifteenth aspect according to the twelfth aspect, wherein the porous polymeric membrane substrate has a bubble point below 80 pounds per square inch, and the coated porous polymeric membrane flow time is not more than 30% greater than the flow time of the uncoated membrane substrate.

A sixteenth aspect according to any of the twelfth through fifteenth aspects wherein the crosslinker monomer comprises a di-ethylenically-unsaturated monomer.

A seventeenth aspect according to the sixteenth aspect, wherein the di-ethylenically-unsaturated monomer comprises a di-ethylenically-unsaturated cationic monomer, a di-ethylenically-unsaturated anionic monomer, a di-ethylenically-unsaturated zwitterionic monomer, or any combination thereof.

An eighteenth aspect according to any of the twelfth through seventeenth aspects, wherein the porous polymeric membrane substrate comprises polyphenylsulfone and the coated porous polymeric membrane has a dye binding capacity of greater than 5 micrograms per square centimeter.

A nineteenth aspect according to any of the twelfth through eighteenth aspects, wherein the porous polymeric membrane substrate comprises polytetrafluoroethylene and the coated porous polymeric membrane has a dye binding capacity of greater than 50 micrograms per square centimeter.

A twentieth aspect according to any of the twelfth through nineteenth aspects, wherein the porous polymeric membrane substrate comprises polyphenylsulfone and the coated porous polymeric membrane has a deionized water flow time of less than 400 seconds.

A twenty-first aspect according to any of the twelfth through nineteenth aspects, wherein the porous polymeric membrane substrate comprises polytetrafluoroethylene and the coated porous polymeric membrane has a deionized water flow time of less than 400 seconds.

A twenty-second aspect according to any of the twelfth through twenty-first aspects, wherein the coated porous polymeric membrane is characterized as removing, from purified water, at least 40 percent of one or more of the following metal ions: vanadium, iron, molybdenum, tin, tantalum, and tungsten.

A twenty-third aspect according to any of the twelfth through twenty-second aspects, wherein the coated porous polymeric membrane is characterized as removing, from purified water, at least 60 percent of one or more of the following metal ions: molybdenum, tin, tantalum, and tungsten.

In a twenty-fourth aspect, the present disclosure relates to a multilayer filter membrane comprising: the coated porous polymeric membrane of any of the first through twenty-third aspects, and a nonwoven membrane having an anionic charge.

In a twenty-fifth aspect, the present disclosure relates to a filter product comprising a filter housing, an inlet, an outlet, and the coated porous polymeric membrane of any of the first through twenty-third aspects or the multilayer filter membrane of the twenty-fourth aspect.

In a twenty-sixth aspect, the present disclosure relates to a method of removing metal ions from purified water, the method comprising flowing purified water that contains metal ions through the coated porous polymeric membrane of any of the first through twenty-third aspects, the multilayer filter membrane of the twenty-fourth aspect, or the filter product of the twenty-fifth aspect to remove metal ions from the purified water.

A twenty-seventh aspect according to the twenty-sixth aspect comprising removing from the purified water at least 40 percent of one or more of the following metal ions: vanadium, iron, molybdenum, tin, tantalum, and tungsten.

A twenty-eighth aspect according to the twenty-sixth or twenty-seventh aspects comprising removing from the purified water at least 60 percent of one or more of the following metal ions: molybdenum, tin, tantalum, and tungsten.

In a twenty-ninth aspect, the present disclosure relates to a method of preparing a coated porous polymeric membrane capable of removing metal ions from purified water, comprising a porous polymeric membrane substrate and an ionic polymer coating at a surface of the membrane substrate, the method comprising: to a surface of a porous polymeric membrane substrate, applying monomer solution comprising ionic monomer, crosslinker monomer, solvent, and optional initiator, drying the monomer solution on the surface to remove solvent from the monomer solution and form dried monomer coating at the surface, wetting the dried monomer coating with wetting solvent to form re-wetted monomer coating at the surface, reacting monomer of the re-wetted monomer to form ionic polymer coating at the surface.

A thirtieth aspect according to the twenty-ninth aspect comprising after reacting the re-wetted monomer at the surface to form cationic polymer coating at the surface, extracting the membrane using extracting solvent.

A thirty-first aspect according to the twenty-ninth or thirtieth aspect, wherein the ionic monomer comprises di-ethylenically-unsaturated cationic monomer.

A thirty-second aspect according to any of the twenty-ninth through the thirty-first aspects, wherein the ionic monomer comprises di-ethylenically unsaturated anionic monomer.

A thirty-third aspect according to any of the twenty-ninth through thirty-second aspects, wherein the ionic monomer comprises di-ethylenically unsaturated zwitterionic monomer.

A thirty-fourth aspect according to any of the twenty-ninth through thirty-third aspects, wherein the crosslinker monomer comprises an un-charged di-ethylenically-unsaturated monomer.

A thirty-fifth aspect according to any of the twenty-ninth through thirty-fourth aspects, wherein the wetting solvent comprises one or more of: decamethyl tetra siloxane, perfluorinated polyether (PFPE), hexylene glycol, dipropylene glycol, fluorinated triethylene glycol monobutyl ether.

Certain embodiments of the present disclosure were described above. It is, however, expressly noted that the present disclosure is not limited to those embodiments, but rather the intention is that additions and modifications to what was expressly described in the present disclosure are also included within the scope of the disclosure. Moreover, it is to be understood that the features of the various embodiments described in the present disclosure were not mutually exclusive and can exist in various combinations and permutations, even if such combinations or permutations were not made express, without departing from the spirit and scope of the disclosure. The disclosure has been described in detail with particular reference to certain embodiments thereof, but it will be understood that variations and modifications can be effected within the spirit and scope of the claimed invention.

1. A coated porous polymeric membrane comprising:
(i) a porous polymeric membrane substrate exhibiting:
(a) a substrate flow time measured as deionized water flow time, and
(b) a bubble point in a range from 2 to 200 pounds per square inch measured using ethoxy-nonafluorobutane; and
(ii) an ionic polymer coating at a surface of the porous polymeric membrane substrate, the ionic polymer coating comprising monomeric units derived from an ionic monomer and a crosslinker monomer; wherein
the coated porous polymeric membrane exhibits a coated membrane flow time measured as deionized water flow time, the coated membrane flow time being no more than 50% greater than the substrate flow time of the porous polymeric membrane substrate when it does not have the ionic polymer coating.

2. The coated porous polymeric membrane of claim 1, wherein
the porous polymeric membrane substrate has a bubble point greater than 140 pounds per square inch, and
the coated membrane flow time is no more than 50% greater than the substrate flow time of the porous polymeric membrane substrate when it does not have the ionic polymer coating.

3. The coated porous polymeric membrane of claim 1, wherein
the porous polymeric membrane substrate has a bubble point between 80 pounds per square inch and 140 pounds per square inch, and
the coated porous polymeric membrane flow time is not more than 40% greater than the substrate flow time of the porous polymeric membrane substrate when it does not have the ionic polymer coating.

4. The coated porous polymeric membrane of claim 1, wherein
the porous polymeric membrane substrate has a bubble point below 80 pounds per square inch, and
the coated porous polymeric membrane flow time is not more than 30% greater than the flow time of the uncoated membrane substrate.

5. The coated porous polymeric membrane of claim 1 wherein the crosslinker monomer comprises a di-ethylenically-unsaturated monomer.

6. The coated porous polymeric membrane of claim 5, wherein the di-ethylenically-unsaturated monomer comprises a di-ethylenically-unsaturated cationic monomer, a di-ethylenically-unsaturated anionic monomer, a di-ethylenically-unsaturated zwitterionic monomer, or any combination thereof.

7. The coated porous polymeric membrane of claim 1, wherein the porous polymeric membrane substrate comprises polyphenylsulfone and the coated porous polymeric membrane has a dye binding capacity of greater than 5 micrograms per square centimeter.

8. The coated porous polymeric membrane of claim 1, wherein the porous polymeric membrane substrate comprises polytetrafluoroethylene and the coated porous polymeric membrane has a dye binding capacity of greater than 50 micrograms per square centimeter.

9. The coated porous polymeric membrane of claim 1, wherein the porous polymeric membrane substrate comprises polyphenylsulfone and the coated porous polymeric membrane has a deionized water flow time of less than 400 seconds.

10. The coated porous polymeric membrane of claim 1, wherein the porous polymeric membrane substrate comprises polytetrafluoroethylene and the coated porous polymeric membrane has a deionized water flow time of less than 400 seconds.

11. The coated porous polymeric membrane of claim 1, wherein the coated porous polymeric membrane is characterized as removing, from purified water, at least 40 percent of one or more of the following metal ions: vanadium, iron, molybdenum, tin, tantalum, and tungsten.

12. The coated porous polymeric membrane of claim 1, wherein the coated porous polymeric membrane is characterized as removing, from purified water, at least 60 percent of one or more of the following metal ions: molybdenum, tin, tantalum, and tungsten.

13. A method of removing metal ions from purified water, the method comprising:
flowing purified water that contains metal ions through the coated membrane of claim 1 thereby removing metal ions from the purified water.

14. The method of claim 13, comprising removing from the purified water at least 40 percent of one or more of the following metal ions: vanadium, iron, molybdenum, tin, tantalum, and tungsten.

15. The method of claim 13, comprising removing from the purified water at least 60 percent of one or more of the following metal ions: molybdenum, tin, tantalum, and tungsten.
